(19) United States
(12) Patent Application Publication
(10) Pub. No.: US 2013/0312254 A1
(43) Pub. Date: Nov. 28, 2013

(54) METHOD FOR MANUFACTURING A VALUABLE-METAL SULFURIC-ACID SOLUTION FROM A WASTE BATTERY, AND METHOD FOR MANUFACTURING A POSITIVE ELECTRODE ACTIVE MATERIAL

(71) Applicants: Soo Kyung Kim, Daejeon (KR); Jin Gu Kang, Daejeon (KR); Dong Hyo Yang, Daejeon (KR); Jeong Soo Sohn, Daejeon (KR); Shun Myung Shin, Daejeon (KR)

(72) Inventors: Soo Kyung Kim, Daejeon (KR); Jin Gu Kang, Daejeon (KR); Dong Hyo Yang, Daejeon (KR); Jeong Soo Sohn, Daejeon (KR); Shun Myung Shin, Daejeon (KR)

(73) Assignee: KOREA INSTITUTE OF GEOSCIENCE AND MINERAL RESOURCES, Daejeon (KR)

(21) Appl. No.: 13/877,291

(22) PCT Filed: Aug. 18, 2011
(86) PCT No.: PCT/KR11/06086

§ 371 Date: Apr. 1, 2013

(30) Foreign Application Priority Data
Feb. 17, 2011 (KR) 10-2011-0013991

(51) Int. Cl. H01M 10/54

(52) U.S. Cl. CPC H01M 10/54
USPC 29/623.1; 423/49; 423/50

(57) ABSTRACT

The present invention relates to a method for manufacturing a valuable-metal sulfuric-acid solution from a waste battery, and to a method for manufacturing a positive electrode active material. The method for manufacturing the valuable-metal sulfuric-acid solution includes: a step of obtaining valuable-metal powder containing lithium, nickel, cobalt, and manganese from waste batteries; a step of acid-leaching the valuable-metal powder under a reducing atmosphere in order to obtain a leaching solution; and a step of separating the lithium from the leaching solution so as to obtain a sulfuric-acid solution containing the nickel, cobalt, and manganese.

### TECHNICAL FIELD

The present invention relates to a method of manufacturing a valuable-metal sulfuric acid solution from a waste battery, and to a method of manufacturing a positive electrode active material.

### BACKGROUND ART

Recently, use of a battery pack including a plurality of unit battery cells has been increased. A battery pack includes a plurality of battery modules electrically connected to one another and the battery module includes a plurality of battery cells electrically connected to one another.

Such battery packs have been widely used in electric vehicles (EVs) or hybrid electric vehicles (HEVs) requiring high electric capacity.

EVs or HEVs have been on the spotlight as a mean for addressing the issue of climate change due to the greenhouse effect as a global environmental issue, and it is expect that the production volume of EV or HEV will be rapidly increased.

Lithium-ion batteries are widely used as battery cells used in EVs or HEVs and at this time, materials in the form of LiNiₓCo_{y}Mn_{z}O₂ are widely used as a positive electrode active material.

It is expected that waste battery packs generated from electric vehicles will also be rapidly increased in the future. However, a method of recycling a positive electrode active material has not been suggested.

### DISCLOSURE OF THE INVENTION

### Technical Problem

The present invention provides a method of manufacturing a valuable-metal sulfuric acid solution from a waste battery and a method of manufacturing a positive electrode active material.

### Technical Solution

According to an aspect of the present invention, a method of manufacturing a valuable-metal sulfuric acid solution from a waste battery includes: obtaining valuable-metal powder including lithium, nickel, cobalt, and manganese from a waste battery; acid leaching the valuable-metal powder with an acid solution including a sulfuric acid solution in a reducing atmosphere to obtain a leaching solution; and separating lithium from the leaching solution to obtain nickel, cobalt, and manganese sulfuric acid solutions.

The method may further include removing at least one impurity of copper, aluminum, and iron by increasing pH, after the obtaining of the leaching solution.

The separating of the lithium may be performed by using a molecular sieve.

The separating of the lithium may be performed by separating nickel, manganese, and cobalt from the leaching solution by using a solvent extraction method, and a process of stripping the separated nickel, manganese, and cobalt with a sulfuric acid solution may be further included.

The method may further include obtaining lithium carbonate by carbonating the separated lithium.

The method may further include adjusting respective concentrations of nickel, manganese, and cobalt in the leaching solution, after the obtaining of the leaching solution or the removing of the impurity.

The waste battery may be in a form of a waste battery pack, and the waste battery pack may include a plurality of battery modules electrically connected, the battery module may include a plurality of battery cells electrically connected, and the battery cell may be a type of a lithium-ion battery using LiNiₓCo_{y}Mn_{z}O₂ as a positive electrode active material, wherein the obtaining of the valuable-metal powder may include: disassembling the waste battery pack to obtain the battery cells; discharging the battery cells; and recovering the valuable-metal powder by pulverizing at least a portion of the battery cells and performing particle size separation.

The method may further include dehydrating and drying the battery cells, after the discharging, wherein the discharging may be performed in a discharge solution.

The method may further include separating the battery cell into a positive electrode structure, a negative electrode structure, and a separator, after the discharging, wherein the pulverization and the particle size separation may be performed on the positive electrode structure.

The positive electrode structure may include: an aluminum foil; and the positive electrode active material fixed to the aluminum foil, wherein the pulverization and the particle size separation may be performed to recover 95% or more of lithium, nickel, cobalt, and manganese, and 15% or less of aluminum.

The waste battery pack may be obtained at least any one of a hybrid vehicle and an electric vehicle.

According to another aspect of the present invention, a method of manufacturing a positive electrode active material from a waste battery includes: obtaining valuable-metal powder including lithium, nickel, cobalt, and manganese from a waste battery; acid leaching the valuable-metal powder in a reducing atmosphere to obtain a leaching solution; separating lithium from the leaching solution to obtain nickel, cobalt, and manganese sulfuric acid solutions; preparing ternary hydroxide from the nickel, cobalt, and manganese sulfuric acid solutions by using a coprecipitation method through adjustment of pH; and manufacturing a positive electrode active material by mixing and sintering the ternary hydroxide and a lithium compound.

The method may further include removing at least one impurity of copper, aluminum, and iron by increasing pH, after the obtaining of the leaching solution.

The separating of the lithium may be performed by using a molecular sieve.

The separating of the lithium may be performed by separating nickel, manganese, and cobalt from the leaching solution by using a solvent extraction method, and a process of stripping the separated nickel, manganese, and cobalt with a sulfuric acid solution may be further included.

The lithium compound may include lithium carbonate obtained by carbonating the separated lithium.

The waste battery may be in a form of a waste battery pack, and the waste battery pack may include a plurality of battery modules electrically connected, the battery module may include a plurality of battery cells electrically connected, and the battery cell may be a type of a lithium-ion battery using LiNiₓCo_{y}Mn_{z}O₂ as a positive electrode active material, wherein the obtaining of the valuable-metal powder may include: disassembling the waste battery pack to obtain the battery cells; discharging the battery cells; and recovering the valuable-metal powder by pulverizing at least a portion of the battery cells and performing particle size separation.

According to another aspect of the present invention, a method of manufacturing a positive electrode active material includes: discharging a battery cell having a type of a lithium-ion battery using LiNiₓCo_{y}Mn_{z}O₂ as a positive electrode active material; separating the battery cell into a positive electrode structure including the positive electrode active material, a negative electrode structure, and a separator; obtaining valuable-metal powder including lithium, nickel, cobalt, and manganese by pulverizing the positive electrode structure and performing particle size separation; acid leaching the valuable-metal powder in a reducing atmosphere to obtain a leaching solution; obtaining nickel, cobalt, and manganese sulfuric acid solutions, and lithium carbonate (Li₂CO₃) from the leaching solution; obtaining ternary hydroxide of nickel, cobalt, and manganese from the sulfuric acid solutions; and obtaining a positive electrode active material in a form of LiNiₓCo_{y}Mn_{z}O₂ by mixing and heat treating the ternary hydroxide and the lithium carbonate.

### Advantageous Effects

According to the present invention, a method of effectively manufacturing a valuable-metal sulfuric acid solution from a waste battery and a method of environmentally-friendly and economically manufacturing a positive electrode active material are provided.

### BRIEF DESCRIPTION OF THE DRAWINGS

FIG. 1 is a flowchart illustrating a method of manufacturing a valuable-metal sulfuric acid solution according to the present invention;

FIG. 2 is a flowchart illustrating another method of manufacturing a valuable-metal sulfuric acid solution according to the present invention;

FIG. 3 is a flowchart illustrating a method of recovering valuable metals according to the present invention;

FIG. 4 illustrates separation of battery modules from a waste battery pack;

FIG. 5 illustrates electrical connections between battery modules in a waste battery pack;

FIG. 6 illustrates separation of battery cells from a battery module;

FIG. 7 illustrates a circuit board separated from a battery module;

FIG. 8 illustrates a frame separated from a battery module;

FIG. 9 illustrates a battery cell separated from a battery module;

FIG. 10 illustrates appearance of a battery cell during discharging;

FIG. 11 illustrates a discharge solution after discharging the battery cell;

FIG. 12 illustrates changes in voltages during a discharge process of battery cells in the case that a discharge solution is not supplemented;

FIG. 13 illustrates changes in voltages during a discharge process of battery cells in the case that a discharge solution is supplemented;

FIG. 14 illustrates dryness efficiency in the case that discharged battery cells are dried after dehydration;

FIG. 15 illustrates dryness efficiency in the case that discharged battery cells are dried without dehydration;

FIG. 16 illustrates discharged and dried battery cells;

FIG. 17 illustrates a negative electrode structure separated from the discharged and dried battery cell;

FIG. 18 illustrates a positive electrode structure separated from the discharged and dried battery cell;

FIG. 19 illustrates enrichment ratios of the positive electrode structure according to pulverization time and particle size;

FIG. 20 illustrates enrichment ratios of each valuable metal according to pulverization time in the case that the positive electrode structure having a particle size of −8 mesh is separated;

FIG. 21 illustrates enrichment ratios of each valuable metal according to pulverization time in the case that the positive electrode structure having a particle size of −18 mesh is separated;

FIG. 22 illustrates enrichment ratios of each valuable metal according to pulverization time in the case that the positive electrode structure having a particle size of −40 mesh is separated;

FIG. 23 illustrates enrichment ratios of each valuable metal according to pulverization time in the case that the positive electrode structure having a particle size of −65 mesh is separated; and

FIG. 24 illustrates sulfuric acid reduction leaching behavior of valuable-metal powder.

### MODE FOR CARRYING OUT THE INVENTION

In the present invention, a valuable-metal sulfuric acid solution may be obtained from a battery pack for an electric vehicle, particularly a hybrid electric vehicle (HEV). However, the present invention is not limited thereto.

A waste battery pack includes a plurality of battery modules electrically connected to one another and the battery module includes a plurality of battery cells electrically connected to one another. The battery cell is disposed in an aluminum case and includes a positive electrode structure, a separator, an electrolyte, and a negative electrode structure.

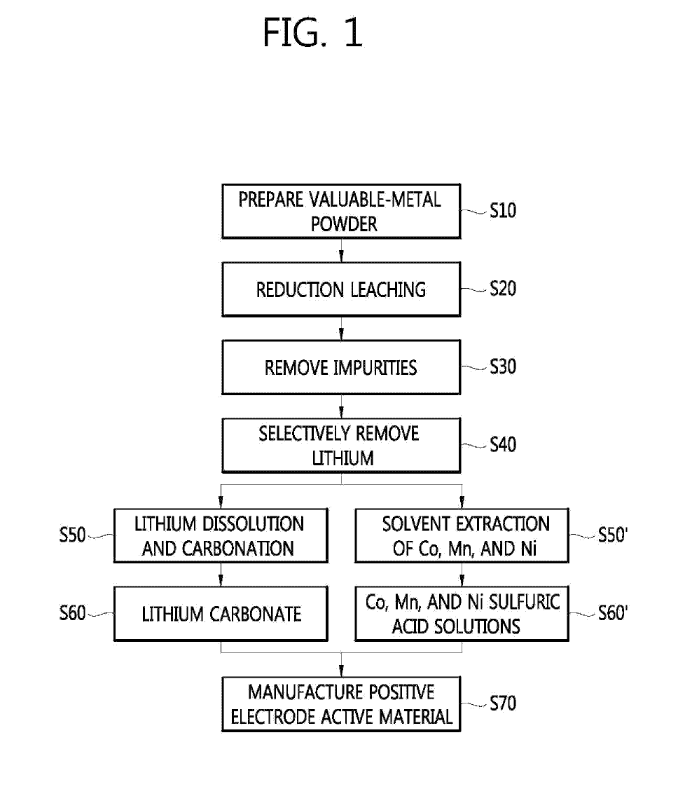

FIG. 1 is a flowchart illustrating a method of manufacturing a valuable-metal sulfuric acid solution and manufacturing a positive electrode active material by using the valuable-metal sulfuric acid solution according to the present invention.

First, valuable-metal powder is prepared from a waste battery pack (S10). This process will be described in detail below. The valuable-metal powder includes lithium (Li), nickel (Ni), manganese (Mn), and cobalt (Co). Also, aluminum is included with the above metals, and trace amounts of copper and iron may be included. A composition of the valuable-metal powder may be somewhat changed according to models and manufacturers of a battery cell.

Thereafter, reduction leaching of the valuable-metal powder is performed (S20). In this process, an acid solution and a reducing agent are added to prepare a leaching solution in which valuable metals are dissolved. A sulfuric acid solution may be used as the acid solution, and hydrogen peroxide may be used as the reducing gent. In addition, Hₑᵣ H₂S, NH₃, and N₂H₄ may also be used as the reducing agent.

Next, the pH of the leaching solution is increased to remove impurities such as aluminum (Al), iron (Fe), and copper (Cu) (S30). The pH thereof is increased by adding a basic solution, for example, NaOH. The pH of the leaching solution may be increased to about 6 to about 7, and more particularly, to 6.5. Solubilities of hydroxides of the impurities relatively decrease as the pH thereof increases and thus, the hydroxides of the impurities may be removed. Since a value of solubility product (Ksp) with respect to Fe(OH)₃ is 1.58×10⁻³⁹, solubility of Fe(OH)₃ at pH 6 is relatively low at 8.8×10⁻²² g/100 g H₂O, and since a value of Ksp with respect to Cu(OH)₂ is 4.79×10⁻²⁰, solubility of Cu(OH)₂ is 3.0×10⁻³ g/100 g H₂O, Since a value of Ksp with respect to Al(OH)₃ is 3.16×10⁻³⁴, solubility of Al(OH)₃ is 8.5×10⁻⁴⁵ g/100 g H₂O. Therefore, most of Fe, Cu, and Al are removed at a pH of less than 6.

Next, lithium is selectively removed from the leaching solution recovered after the removal of the impurities (S40). The selective removal of lithium may be performed by using a method of adsorbing lithium to a molecular sieve. At this time, valuable metals respectively exist in a sulfuric acid solution in the form of ions such as Ni²⁺, Co²⁺, and Mn²⁺. Polysulfonated resins, D4034, SP21-51, CT-175, CT-275, CT-375, or Amberlyst 15 may be used as the molecular sieve.

Lithium adsorbed on the molecular sieve is prepared as lithium carbonate through processes of dissolution and carbonation (S50 and S60). In the process of carbonation, Na₂CO₃ or K₂CO₃ and H₂CO₃ are added at an equivalence ratio corresponding to an amount of moles of lithium in the solution and then stirred to recover as precipitates in the form of Li₂CO₃.

Cobalt, manganese, and nickel are subjected to solvent extraction and a sulfuric acid stripping process to be obtained as a sulfuric acid solution (S50′ and S60′). At this time, cobalt, manganese, and nickel sulfuric acid solutions may be respectively obtained. A phosphinic acid-based, phosphoric acid-based, or phosphonic acid-based acid organic solvent may be used for the solvent extraction.

Finally, a positive electrode active material is manufactured by using the lithium carbonate and the cobalt, manganese, and nickel sulfuric acid solutions thus obtained (S70). Cobalt, manganese, and nickel sulfuric acid solutions are mixed at a desired ratio and ternary hydroxide is then prepared by using a coprecipitation method through the adjustment of pH. The ternary hydroxide is mixed with the lithium carbonate and the positive electrode active material is then manufactured by sintering. In the above process, some of the cobalt, manganese, and nickel sulfuric acid solutions and the lithium carbonate may be obtained from other routes different from that of the present invention. Also, the cobalt, manganese, and nickel sulfuric acid solutions may be used in addition to the manufacturing of the positive electrode active material.

Currently, commercial positive electrode active materials are also manufactured by preparation of ternary hydroxide, mixing the ternary hydroxide with lithium carbonate, and sintering. In the above process, a Ni salt, a Co salt, a Mn salt (most of them are sulfates), and lithium carbonate as raw materials are produced from natural resources through processes such as mining, ore dressing, and smelting. In particular, solutions including metals are crystallized in the smelting process and prepared as powders, and the powders are sold. The powders are imported by domestic companies and a process of redissolving in the form of a solution is performed.

Since the metal sulfuric acid solutions obtained in the present invention may be directly used in the process of manufacturing a ternary positive electrode active material, the current process may be used and the process may be simplified. Also, since generation of wastewater and wastes may be decreased due to the simplified process, environmental friendliness may be secured. In addition, since raw materials may be recovered from wastes, the destruction of nature due to mining and ore dressing may be prevented and natural resources may be conserved, and thus, the process according to the present invention may have environmental friendliness and economic factors in comparison to typical processes.

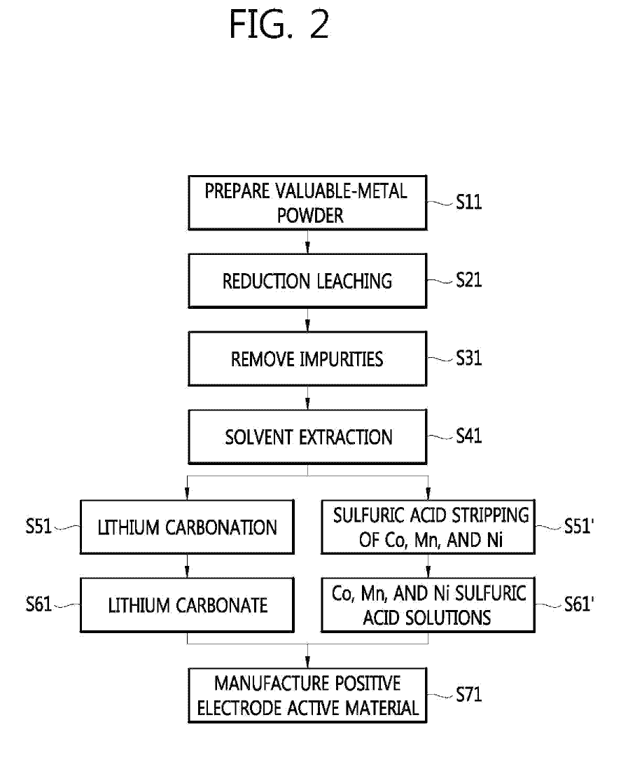

FIG. 2 is a flowchart illustrating another method of manufacturing a valuable-metal sulfuric acid solution and a positive electrode active material according to the present invention.

Differing from FIG. 1, nickel, manganese, and cobalt are separated in advance (S41) by performing solvent extraction after removal of impurities (S31). When the above process is performed, contents of impurities in addition to nickel, manganese, and cobalt may be further reduced. Lithium separated and recovered as a raffinate is obtained as lithium carbonate (S61) through lithium carbonation (S51). Na₂CO₃ or K₂CO₃ and H₂CO₃ may be used for the lithium carbonation. The solvent extracted nickel, manganese, and cobalt are subjected to sulfuric acid stripping (S51′) to be obtained as respective metal sulfuric acid solutions (S61′).

In the foregoing two methods, a process of adjusting a concentration of each metal component may be added after the reduction extraction or the removal of the impurities. When deficient components are determined through the analysis of components in the recovered solution, a composition of Ni, Mn, and Co in the solution may be adjusted to be constant by using manganese sulfate, cobalt sulfate, and nickel sulfate. Companies manufacturing ternary positive electrode active materials for a lithium-ion battery may adjust manufacturing specifications through the above process.

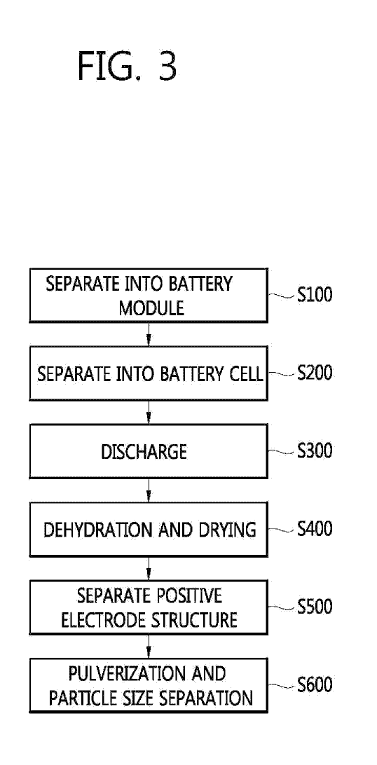

A process of obtaining valuable-metal powder from a waste battery pack will be described below with reference to FIG. 3.

First, a waste battery pack is separated into battery modules (S100). In this process, voltage of the waste battery pack is checked and electrical connections between the battery modules are removed. Also, screws connecting between the battery modules are removed. This process may be manually performed.

Next, the battery modules are separated into battery cells (S200). A circuit board, a frame, and battery cells are included in the battery module, and the circuit board and the frame are recycled separately. This process may also be manually performed.

Next, the battery cells are discharged for work safety (S300). When the discharge is completed, a subsequent valuable-metal recovery process may be safely performed even in air, which is not an inert atmosphere. The discharge may be performed in a discharge solution. Distilled water may be used as the discharge solution. A degree of completion of the discharge may be confirmed through a decrease in voltage according to time.

Thereafter, the discharged battery cells are dehydrated and dried (S400). The drying may be performed at a temperature ranging from 60° C. to 90° C. When the dehydration is performed, drying time is decreased, and the drying time may be in a range of 10 hours to 30 hours. The battery cells may be included in an aluminum case and the aluminum case may be removed before the discharge.

Next, a positive electrode structure is separated from the battery cell (S500). Each battery cell is composed of a positive electrode structure, a separator, and a negative electrode structure, and these are separated manually. The positive electrode structure is composed of an aluminum foil and a positive electrode active material fixed thereto, and the positive electrode active material may be LiNiₓCo_{y}Mn_{z}O₂. The separator may be polyethylene or polypropylene. The negative electrode structure may be composed of a copper foil and graphite fixed thereto. Herein, valuable metals as recovery targets are metals constituting the positive electrode active material.

Subsequently, the obtained positive electrode active material is pulverized and then subjected to particle size separation (S600).

The pulverization and particle size separation are performed so as to recover 95% or more of targeted valuable metals and 15% or less of untargeted metals. Even in the case that the pulverization is performed, since particle sizes of the components constituting the positive electrode active material are typically greater than that of the pulverized aluminum foil, a content of impurity (aluminum) may be reduced when a particle size of separation is decreased. A condition of the separation may be set as 65 mesh or less.

### EXAMPLES

Hereinafter, the present invention will be described in detail, according to specific examples. However, the following examples are merely provided to allow for a clearer understanding of the present invention, and it is obvious to those skilled in the art that the scope of the present invention is not limited thereto.

A waste battery pack used in experiments had been used in a golf cart and was composed of 6 unit battery modules, and each battery module was composed of 10 battery cells.

1. Separation into Battery Modules

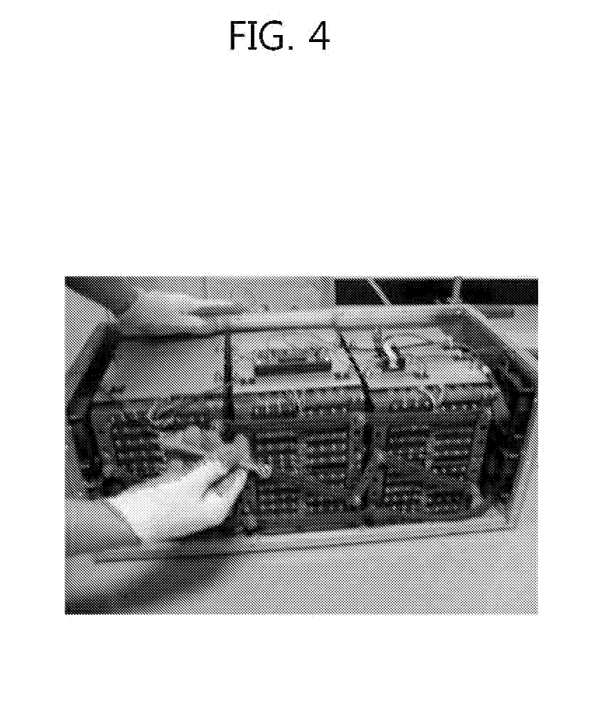

FIG. 4 illustrates separation of battery modules from a waste battery pack. The battery modules had a two-layer structure and 3 battery modules were disposed in each layer. The battery modules in an upper layer and a lower layer were respectively connected in series and the battery modules in the upper layer and the lower layer were also connected in parallel.

In order to safely dissemble each battery module from the battery pack, a voltage of the battery pack was checked and electrical wires connected between the battery modules were not cut all at once, but were sequentially cut one by one.

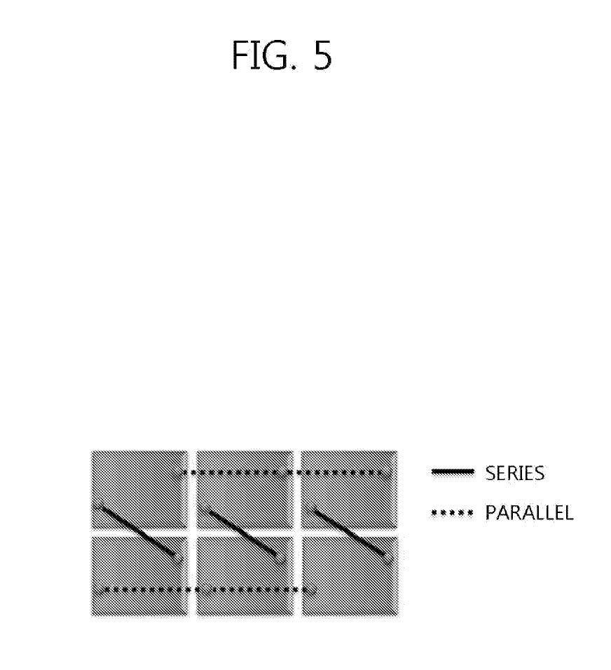

The battery modules in the waste battery pack were connected as in FIG. 5. First, disassembly was performed in a sequence in which connection bars of series parts were first disassembled and connection bars of parallel parts were then disassembled. All connection bars were removed and screws connected between the battery modules were then loosened to separate the battery modules from the battery pack.

The above works were manually performed.

2. Separation into Battery Cells

A top and a bottom of the disassembled battery module was respectively divided with an acryl plate and a circuit board, and since cells were stacked layer by layer, contacts of top and bottom cells must be treated so as not to be in contact with each other, in order to prevent short circuit during disassembling the cells.

Since each battery cell and frame were fixed with a double-sided tape in order to prevent separation between the cells and between the frames fixing the cells, the frames were first removed, and each contact was then cut by using a pair of insulation scissors to perform an operation of disassembling each battery cell.

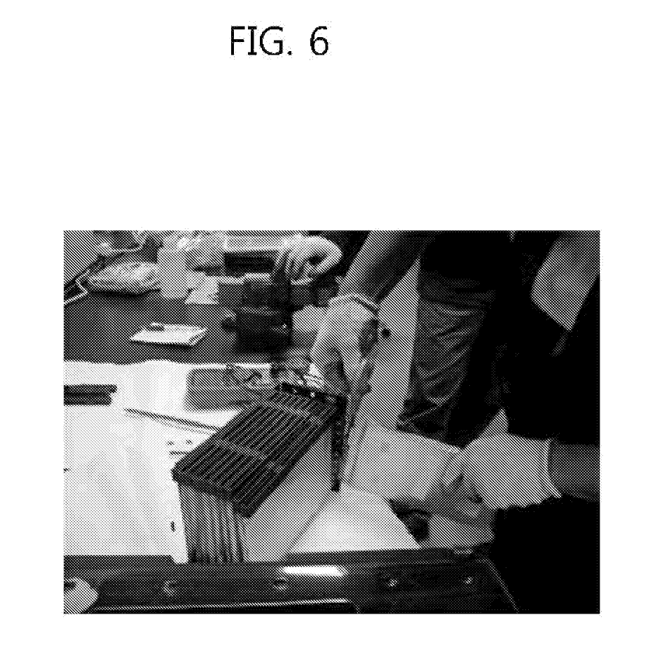

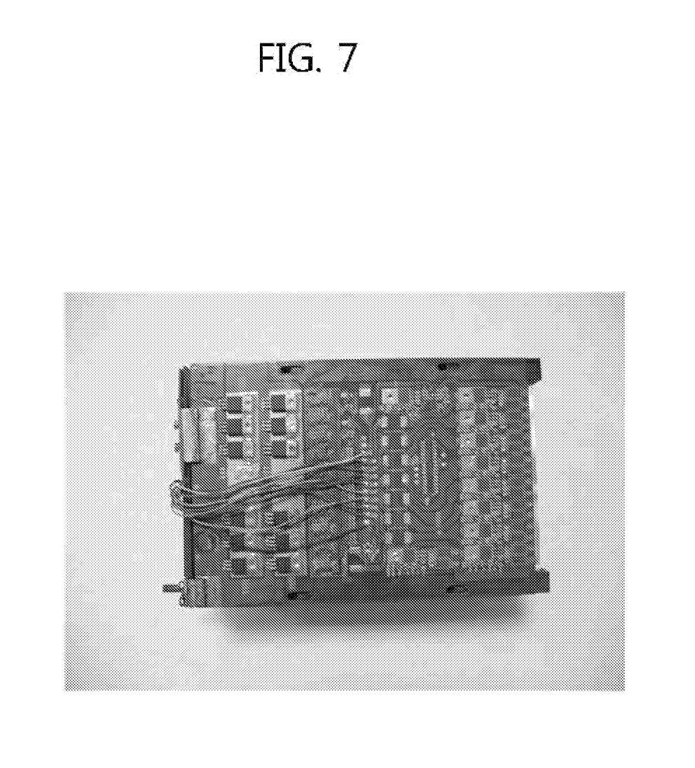

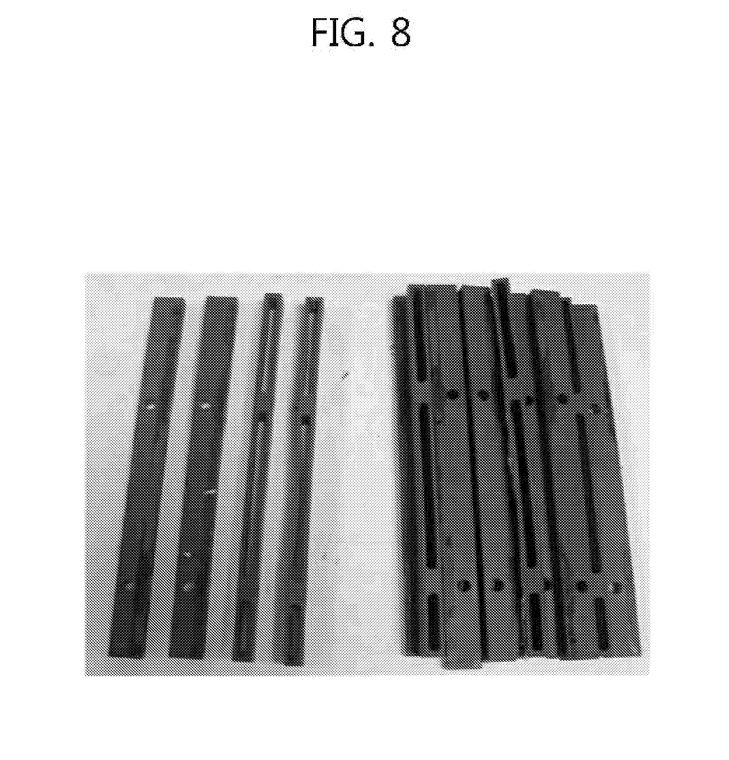

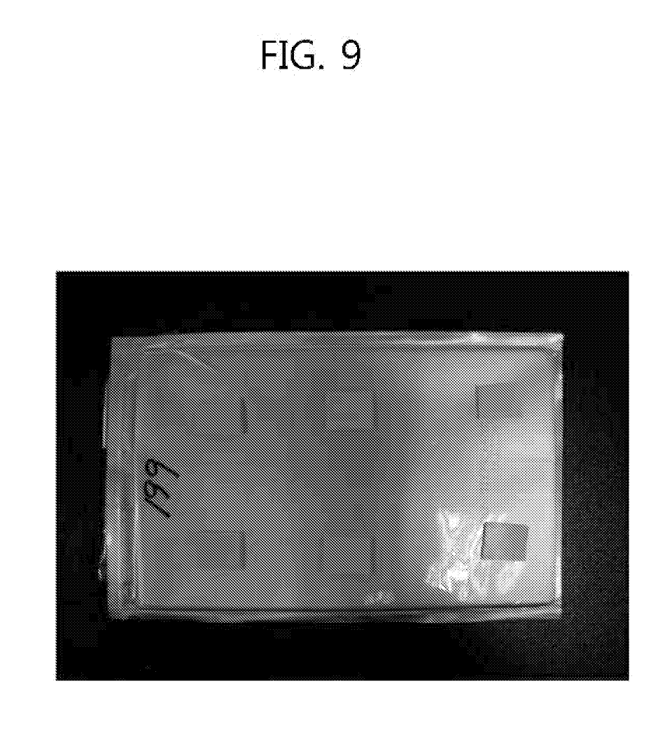

FIG. 6 illustrates a separation operation using a pair of insulation scissors. FIG. 7 illustrates a separated circuit board, FIG. 8 illustrates a separated frame, and FIG. 9 illustrates a separated battery cell. In FIG. 9, the battery cell was encapsulated with an aluminum case.

3. Discharge

The battery cell removed from the aluminum case was put in distilled water and discharge was performed thereon.

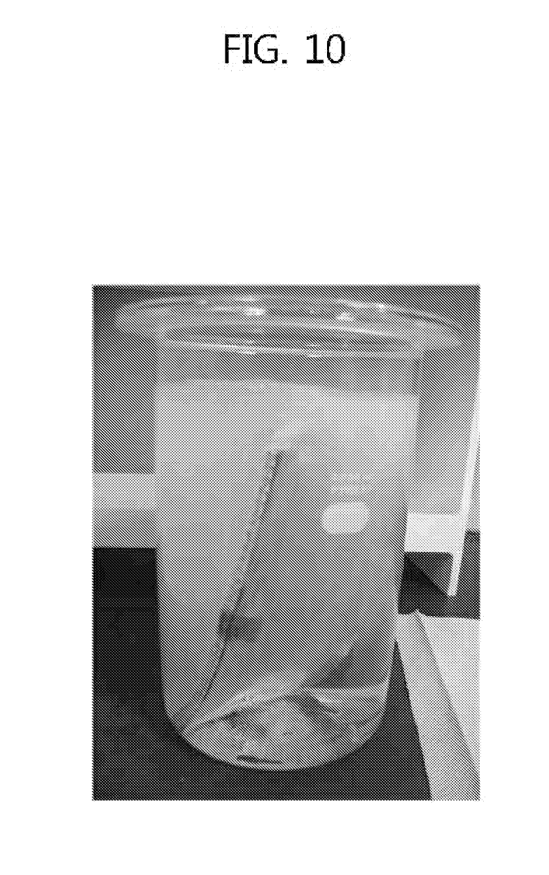

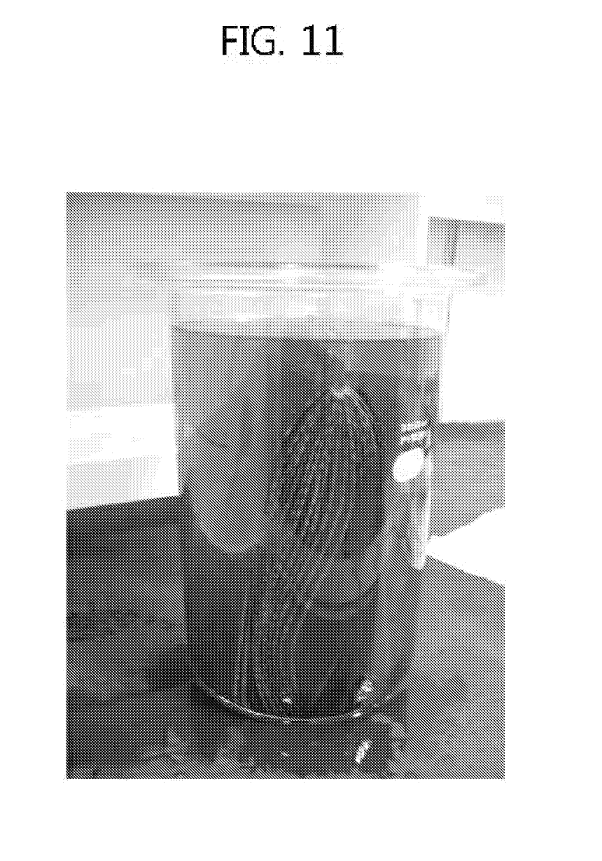

FIG. 10 illustrates appearance of the battery cell during discharge and FIG. 11 illustrates appearance thereof after the completion of discharge.

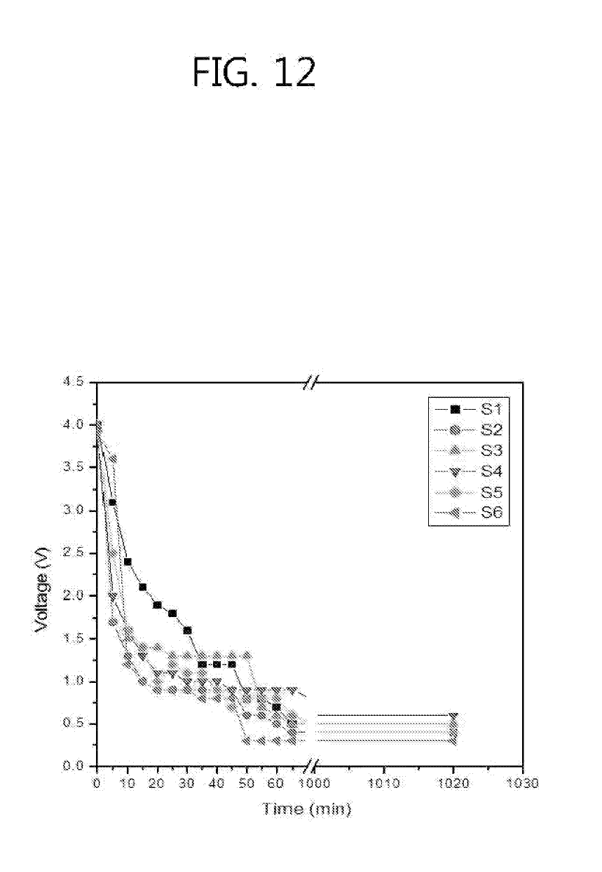

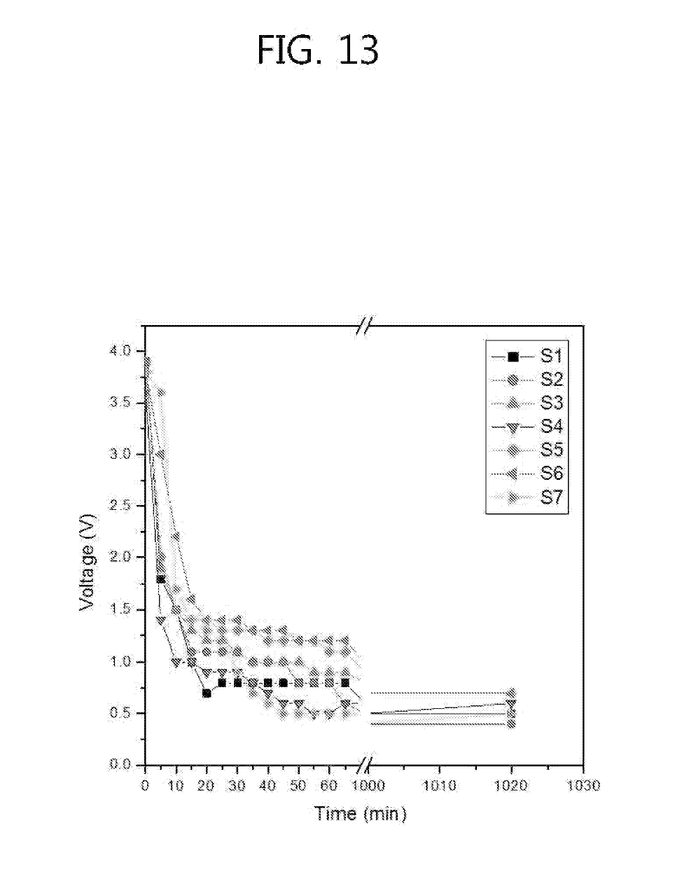

FIGS. 12 and 13 illustrate changes in voltages during discharge. FIG. 12 is for the case that a discharge solution is not supplemented and FIG. 13 is for the case that a discharge solution is supplemented.

It may be confirmed that difference in the changes in voltages between the cases of supplementing the discharge solution and not supplementing the discharge solution was not significant. In the behavior of the changes in voltages, the highest reactions occurred within 5 minutes, and it may be confirmed that voltages were most decreased during this time and, with respect to two discharge reactions, discharges were entirely completed within 70 minutes.

After the discharge, in order to analyze compositions of the battery cells separated and recovered, samples were dissolved by using aqua regia (HCl:HNO₃=3:1) and compositions of the samples were analyzed by inductively coupled plasma (ICP) spectroscopy.

TABLE 1
Results of analyzing chemical compositions
(%) of discharged unit battery cells

| | Co | Mn | Ni | Li | Al | Cu | Fe |
|---|---|---|---|---|---|---|---|
| 1 | 4.9 | 11.9 | 12.5 | 2.3 | 7.2 | 13.0 | 0.04 |
| 2 | 4.9 | 12.0 | 12.1 | 2.2 | 7.2 | 12.7 | 0.04 |
| 3 | 5.0 | 11.7 | 12.3 | 2.2 | 7.1 | 12.8 | 0.04 |
| 4 | 4.7 | 11.1 | 11.4 | 2.1 | 6.8 | 12.2 | 0.04 |
| 5 | 5.7 | 13.2 | 13.4 | 2.5 | 8.1 | 14.5 | 0.04 |
| Ave. | 5.1 | 12.0 | 12.3 | 2.3 | 7.3 | 13.1 | 0.04 |

TABLE 2
Expected ratio of positive electrode active material

| LiNiₓMn_{y}Co_{z}O₂ | Li | Ni | Mn | Co |
|---|---|---|---|---|
| Atomic weight | 6.94 | 58.70 | 54.94 | 58.93 |
| Content (%) | 2.26 | 12.34 | 11.97 | 5.05 |
| Molar ratio | 0.33 | 0.21 | 0.22 | 0.09 |
| Ratio | 1 | 0.6 | 0.7 | 0.3 |

As illustrated in Tables 1 and 2, it may be confirmed that valuable metals in the samples were formed of Co, Mn, Ni, Li, Al, and Cu, and it may be understood that a trace amount of Fe was also included. At this time, it was confirmed that a content of each element was 5.1% Co, 12% Mn, 12.3% Ni, 2.3% Li, 7.3% Al, and 13.1% Cu. A molar ratio of Li:Ni:Mn:Co in LiNiₓMn_{y}Co_{z}O₂ as a positive electrode active material was 1:0.6:0.7:0.3.

4. Dehydration and Drying

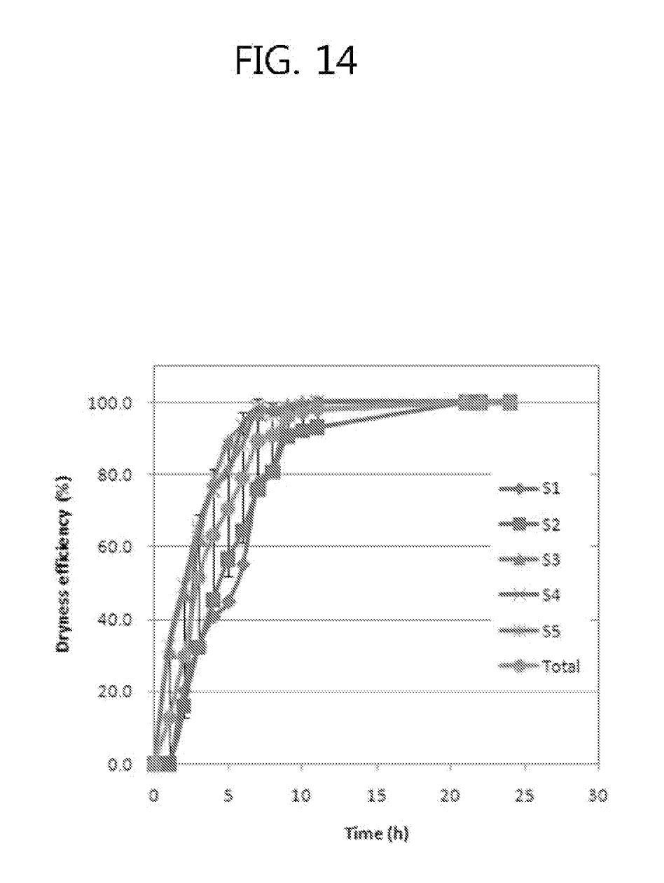

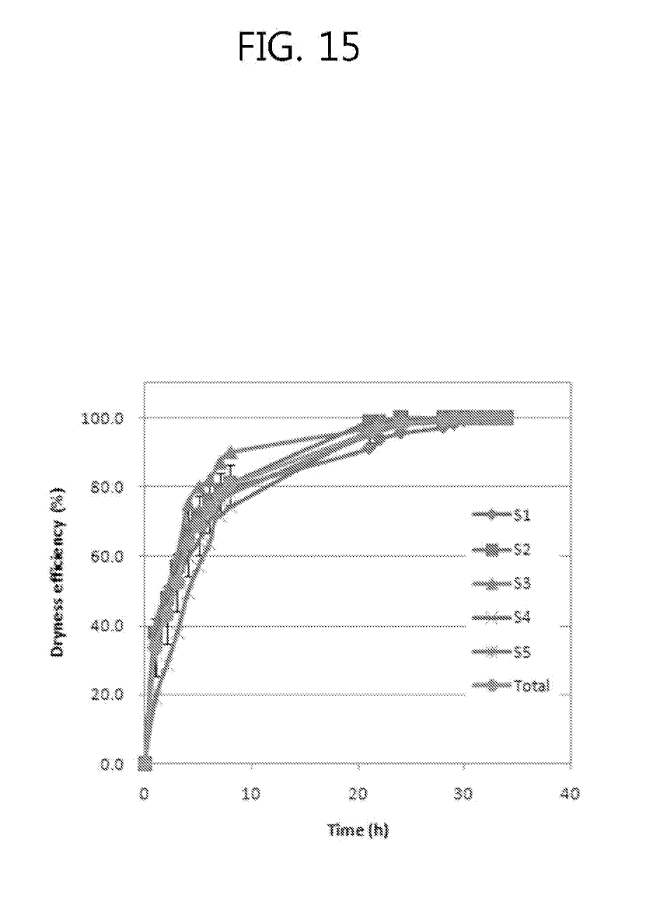

The battery cells were dried at 80° C. after the discharge. FIGS. 14 and 15 illustrate dryness efficiency according to drying time. FIG. 14 is for the case that the discharged battery cells are dried after dehydration by using a dehydrator, and FIG. 15 is for the case that the discharged battery cells are dried without dehydration.

As illustrated in FIG. 14, in the case that dehydration is performed, weights of samples were almost not changed after 10 hours, and thus, it may be confirmed that the samples were completely dried. In contrast, as illustrated in FIG. 15, in the case that dehydration is not performed, it may be confirmed that drying was completed as weights of samples became relatively constant after about 24 hours.

5. Separation of Positive Electrode Active Material

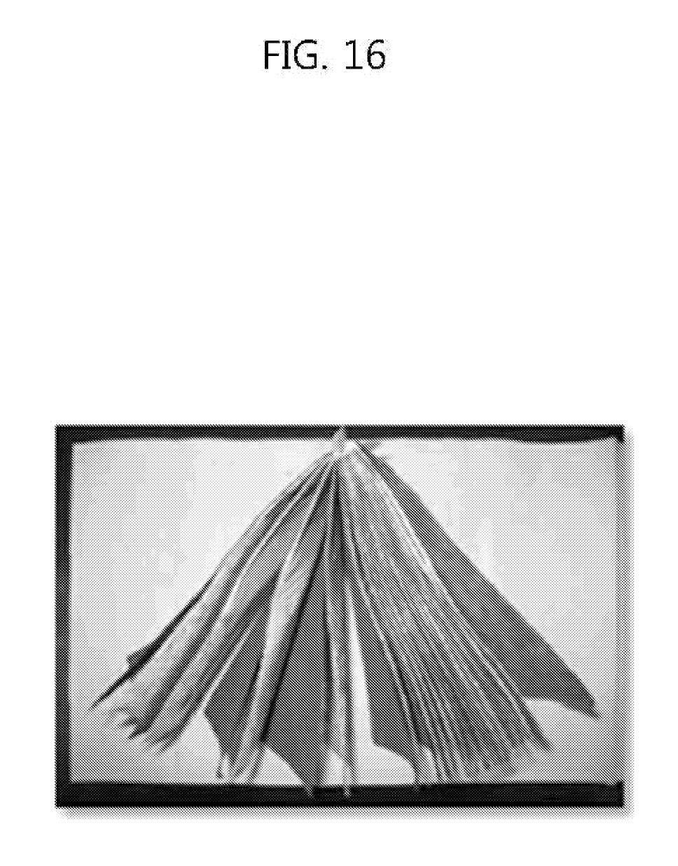

FIG. 16 illustrates battery cells having discharge and drying completed. The battery cell was manually separated into a positive electrode structure, a separator, and a negative electrode structure.

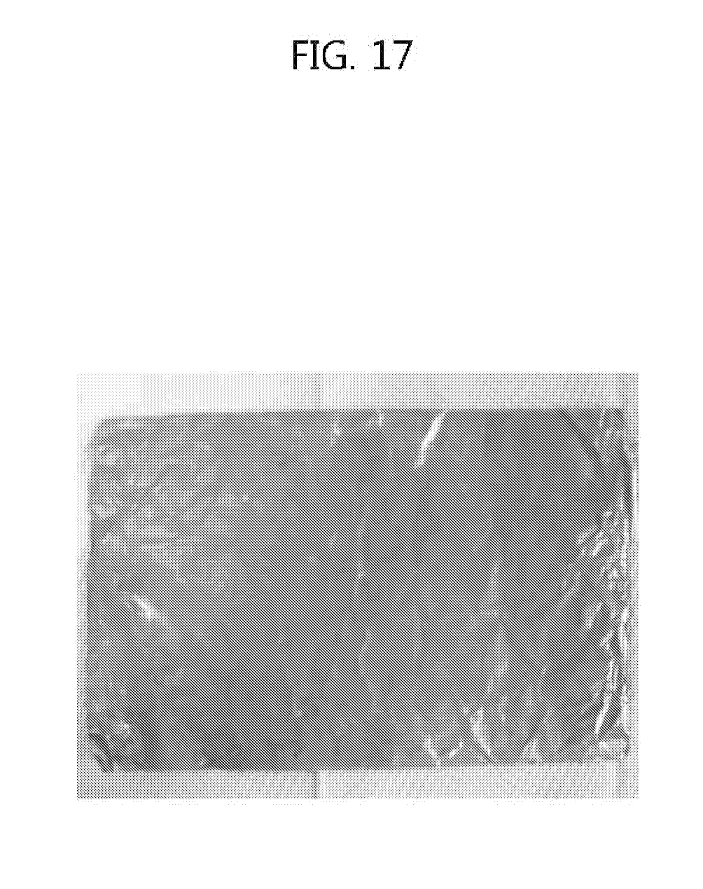

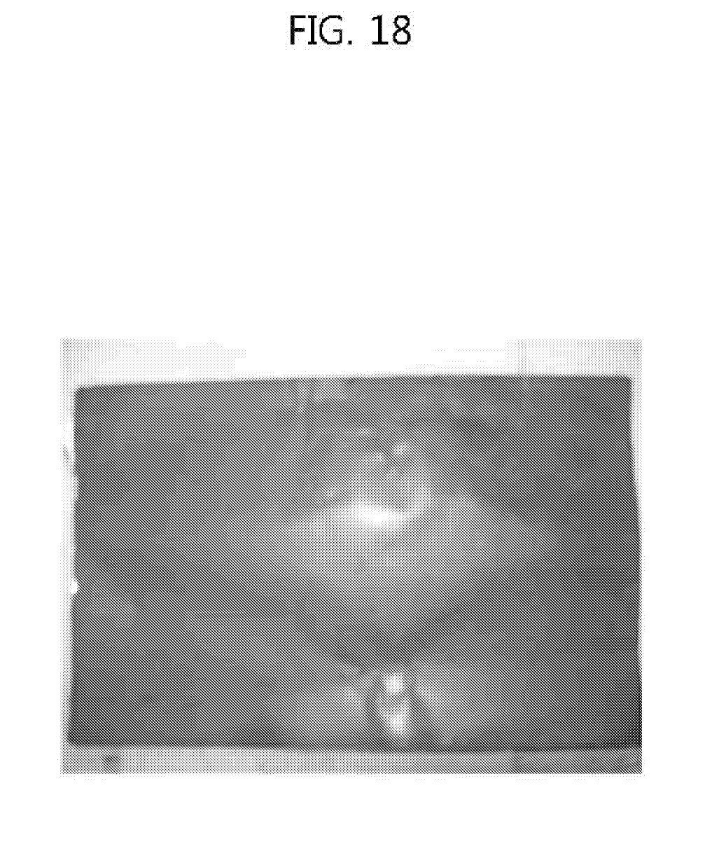

FIG. 17 illustrates a separated negative electrode structure and FIG. 18 illustrates a separated positive electrode structure.

It may be confirmed that graphite as a negative electrode active material was easily separated and detached from a copper foil as a negative electrode in the negative electrode structure. Therefore, it was estimated that the negative electrode structures may be directly recycled in a company manufacturing the same. Also, the separator may also be directly recycled.

In contrast, separation between a positive electrode active material and an aluminum foil as a positive electrode in the positive electrode structure was not observed. Therefore, additional work is required in order to recover valuable metals from the positive electrode structure.

6. Pulverization and Particle Size Separation

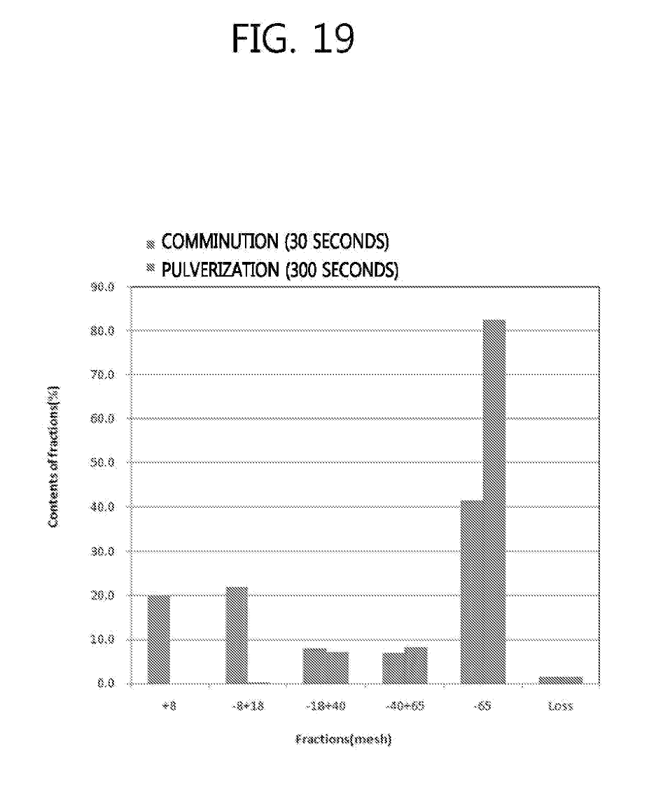

FIG. 19 illustrates enrichment ratios for each particle size according to conditions of pulverization.

As a result of pulverizing 30 g of the recovered positive electrode structure for 30 seconds, enrichment ratios of +8 mesh, −8+18 mesh, −18+40 mesh, −40+65 mesh, and −65 mesh products were 20%, 22%, 8%, 7%, and 41.5%, respectively. It may be understood that contents of the +8 mesh product and the −8+18 mesh product were considerably high in comparison to the −65 mesh product in which the positive electrode active material was enriched.

In the case that pulverization was performed for 5 minutes, contents of +8 mesh, −8+18 mesh, −18+40 mesh, −40+65 mesh, and −65 mesh products were 0%, 0.3%, 7%, 8%, and 83%, respectively. When compared with the experimental result obtained by pulverizing for 30 seconds, it may be confirmed that the contents of the +8 mesh product and the −8+18 mesh product were greatly decreased. In contrast, it may be understood that the content of the −65 mesh product was increased.

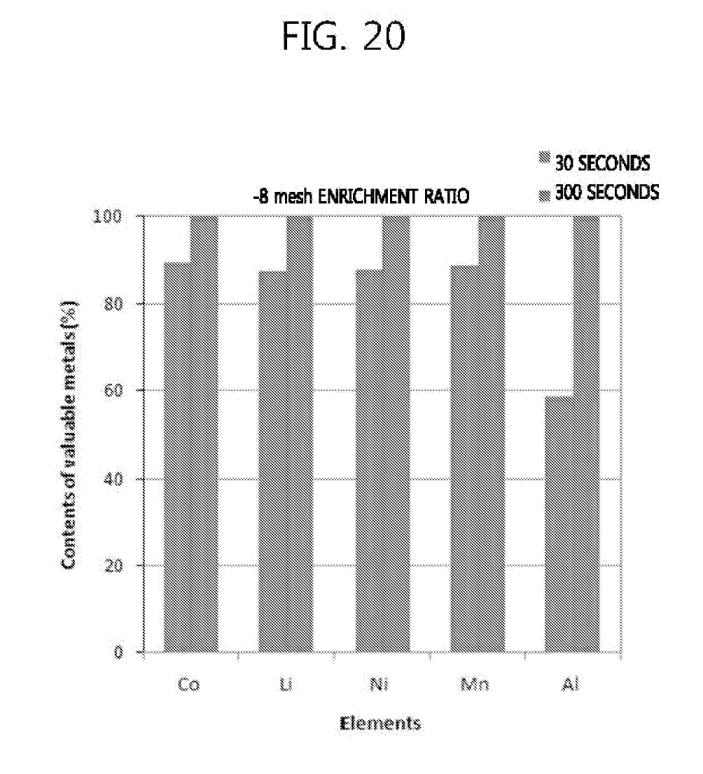

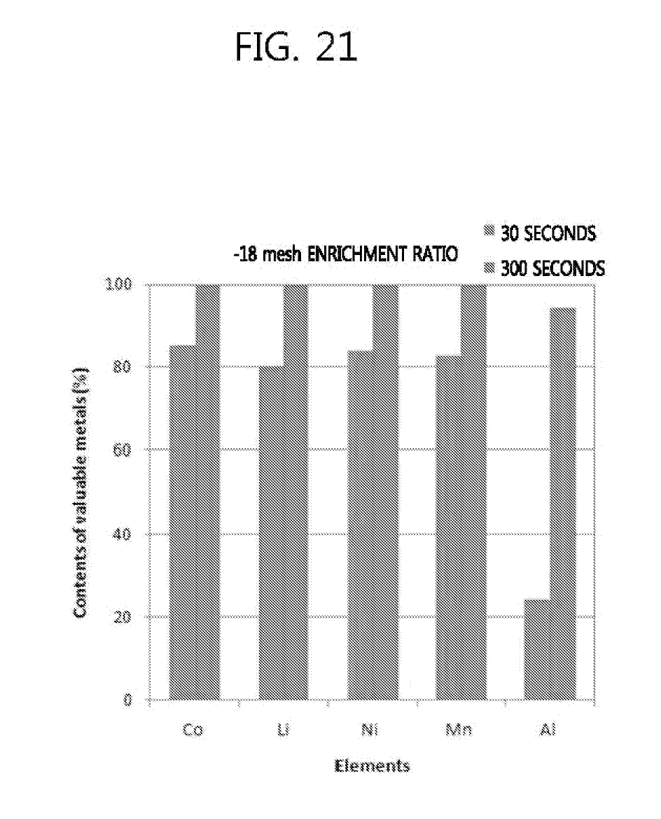

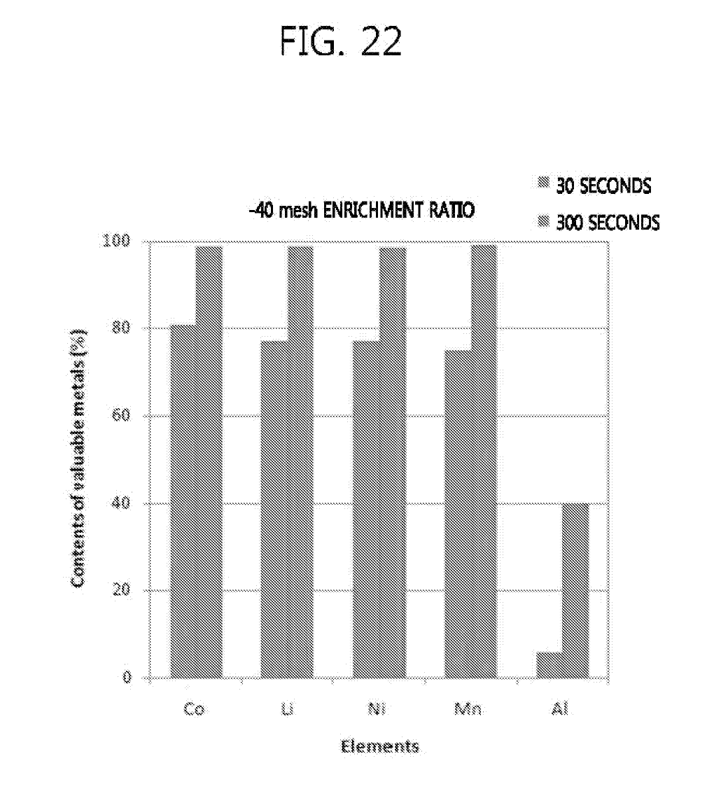

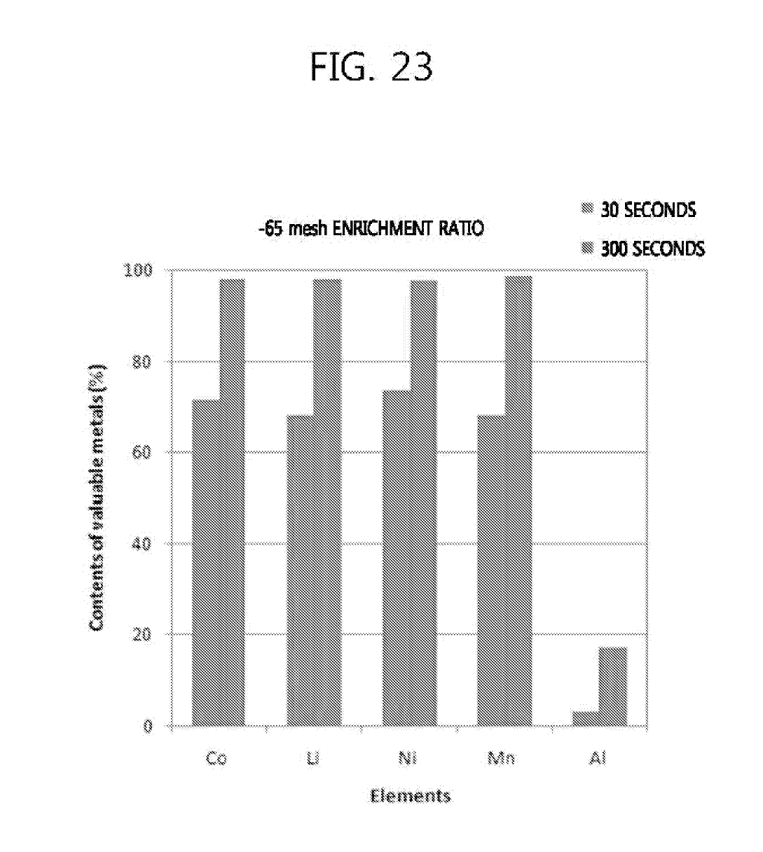

FIGS. 20 through 23 illustrate enrichment ratios of each valuable metal according to pulverization time and particle size. FIG. 20 is for the case of −8 mesh, FIG. 21 is for the case of −18 mesh, FIG. 22 is for the case of −40 mesh, and FIG. 23 is for the case of −65 mesh.

As illustrated in FIGS. 20 through 23, enrichment ratios were close to 100% when a size of mesh was relatively large, but contents of Al as an impurity were high. However, with respect to the −65 mesh product, 95% or more of the ternary positive electrode active material may be enriched and recovered, and with respect to Al as an impurity, 88% or more may be removed.

7. Reduction Leaching

Reduction leaching was performed on the −65 mesh valuable-metal powder. A leaching solution was stirred in a 1000 ml 5-neck Pyrex reactor by using a Teflon impeller having a diameter of 120 mm and a Teflon tube was installed to inject hydrogen peroxide into the solution.

A solid to liquid ratio of the leaching solution and a sample was 1:10 and the temperature was increased to 60° C. while stirring was performed at a speed of 300 rpm after introducing the sample. Concentrations of valuable metals were analyzed for reaction solution samples by using an ICP spectrometer.

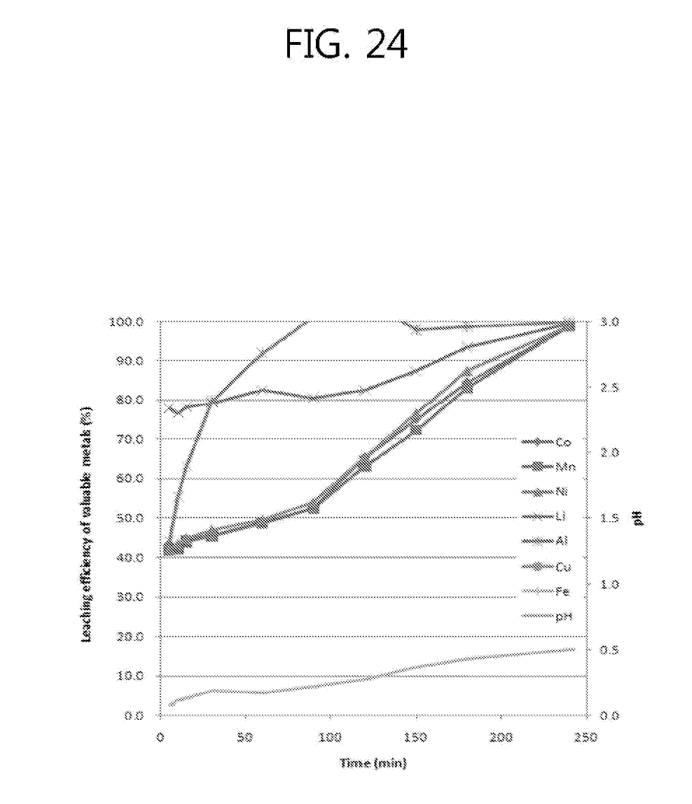

Experimental results obtained by using 2 M sulfuric acid and 5 vol % hydrogen peroxide are presented in FIG. 24. 99% or more of leaching efficiencies of cobalt, nickel, lithium, and manganese as valuable metals were obtained after 4 hours.

A composition of a final sulfuric acid reduction leaching solution is presented in Table 3.

TABLE 3
Composition of sulfuric acid reduction leaching solution
of −65 mesh product enriched by physical treatment

| | Co | Mn | Ni | Li | Al | Cu | Fe | pH | Eh (mV vs. SHE) |
|---|---|---|---|---|---|---|---|---|---|
| mg/L | 7320 | 19300 | 20000 | 5760 | 734 | 11.2 | 29.9 | 0.5 | 1400 |

While the present invention has been particularly shown and described with reference to preferred embodiments thereof, it will be understood by those skilled in the art that various changes in form and details may be made therein without departing from the spirit and scope of the present invention as defined by the appended claims. Therefore, the scope of the present invention is defined not by the detailed description of the invention but by the appended claims and their equivalents.

1. A method of manufacturing a valuable-metal sulfuric acid solution from a waste battery, the method comprising:
obtaining valuable-metal powder including lithium, nickel, cobalt, and manganese from a waste battery;
acid leaching the valuable-metal powder with an acid solution including a sulfuric acid solution in a reducing atmosphere to obtain a leaching solution; and
separating lithium from the leaching solution to obtain nickel, cobalt, and manganese sulfuric acid solutions.

2. The method of claim 1, further comprising removing at least one impurity of copper, aluminum, and iron by increasing pH, after the obtaining of the leaching solution.

3. The method of claim 1, wherein the separating of the lithium is performed by using a molecular sieve.

4. The method of claim 1, wherein the separating of the lithium is performed by separating nickel, manganese, and cobalt from the leaching solution by using a solvent extraction method, and
a process of stripping the separated nickel, manganese, and cobalt with a sulfuric acid solution is further included.

5. The method of claim 1, further comprising obtaining lithium carbonate by carbonating the separated lithium.

6. The method of claim 2, further comprising adjusting respective concentrations of nickel, manganese, and cobalt in the leaching solution, after the obtaining of the leaching solution or the removing of the impurity.

7. The method of claim 1, wherein the waste battery is in a form of a waste battery pack, and
the waste battery pack comprises a plurality of battery modules electrically connected, the battery module comprises a plurality of battery cells electrically connected, and the battery cell is a type of a lithium-ion battery using LiNiₓCo_{y}Mn_{z}O₂ as a positive electrode active material,
wherein the obtaining of the valuable-metal powder comprises:
disassembling the waste battery pack to obtain the battery cells;
discharging the battery cells; and
recovering the valuable-metal powder by pulverizing at least a portion of the battery cells and performing particle size separation.

8. The method of claim 7, further comprising dehydrating and drying the battery cells, after the discharging,
wherein the discharging is performed in a discharge solution.

9. The method of claim 8, further comprising separating the battery cell into a positive electrode structure, a negative electrode structure, and a separator, after the discharging,
wherein the pulverization and the particle size separation are performed on the positive electrode structure.

10. The method of claim 9, wherein the positive electrode structure comprises:
an aluminum foil; and
the positive electrode active material fixed to the aluminum foil,
wherein the pulverization and the particle size separation are performed to recover 95% or more of lithium, nickel, cobalt, and manganese, and 15% or less of aluminum.

11. The method of claim 1, wherein the waste battery pack is obtained at least any one of a hybrid vehicle and an electric vehicle.

12. A method of manufacturing a positive electrode active material from a waste battery, the method comprising:
obtaining valuable-metal powder including lithium, nickel, cobalt, and manganese from a waste battery;
acid leaching the valuable-metal powder in a reducing atmosphere to obtain a leaching solution;
separating lithium from the leaching solution to obtain nickel, cobalt, and manganese sulfuric acid solutions;
preparing ternary hydroxide from the nickel, cobalt, and manganese sulfuric acid solutions by using a coprecipitation method through adjustment of pH; and
manufacturing a positive electrode active material by mixing and sintering the ternary hydroxide and a lithium compound.

13. The method of claim 12, wherein further comprising removing at least one impurity of copper, aluminum, and iron by increasing pH, after the obtaining of the leaching solution.

14. The method of claim 12, wherein the separating of the lithium is performed by using a molecular sieve.

15. The method of claim 12, wherein the separating of the lithium is performed by separating nickel, manganese, and cobalt from the leaching solution by using a solvent extraction method, and
a process of stripping the separated nickel, manganese, and cobalt with a sulfuric acid solution is further included.

16. The method of claim 12, wherein the lithium compound comprises lithium carbonate obtained by carbonating the separated lithium.

17. The method of claim 12, wherein the waste battery is in a form of a waste battery pack, and
the waste battery pack comprises a plurality of battery modules electrically connected, the battery module comprises a plurality of battery cells electrically connected, and the battery cell is a type of a lithium-ion battery using LiNiₓCo_{y}Mn_{z}O₂ as a positive electrode active material,
wherein the obtaining of the valuable-metal powder comprises:
disassembling the waste battery pack to obtain the battery cells;
discharging the battery cells; and
recovering the valuable-metal powder by pulverizing at least a portion of the battery cells and performing particle size separation.

18. A method of manufacturing a positive electrode active material, the method comprising:
discharging a battery cell having a type of a lithium-ion battery using LiNiₓCo_{y}Mn_{z}O₂ as a positive electrode active material;
separating the battery cell into a positive electrode structure including the positive electrode active material, a negative electrode structure, and a separator;
obtaining valuable-metal powder including lithium, nickel, cobalt, and manganese by pulverizing the positive electrode structure and performing particle size separation;
acid leaching the valuable-metal powder in a reducing atmosphere to obtain a leaching solution;
obtaining nickel, cobalt, and manganese sulfuric acid solutions, and lithium carbonate (Li₂CO₃) from the leaching solution;
obtaining ternary hydroxide of nickel, cobalt, and manganese from the sulfuric acid solutions; and
obtaining a positive electrode active material in a form of LiNiₓCo_{y}Mn_{z}O₂ by mixing and heat treating the ternary hydroxide and the lithium carbonate.
